(19) United States
(12) Patent Application Publication
(10) Pub. No.: US 2018/0330403 A1
(43) Pub. Date: Nov. 15, 2018

(54) DIGITAL BILLBOARD SCHEDULER

(71) Applicant: Matthew Joseph Olivieri, San Jose, CA (US)

(72) Inventor: Matthew Joseph Olivieri, San Jose, CA (US)

(21) Appl. No.: 15/594,428

(22) Filed: May 12, 2017

(51) Int. Cl. G06Q 30/02

(52) U.S. Cl. CPC G06Q 30/0264; G06Q 30/0242; G06Q 30/0273

(57) ABSTRACT

For an advertising campaign, an ad scheduler receives input from a user. The input includes a region for an ad campaign, a start date for the ad campaign and an estimated number of impressions within a set period of time for the ad campaign. The ad scheduler schedules the ad campaign in an ad scheduling calendar. A plurality of digital billboards located within the region for the ad campaign displays ads for the ad campaign. The plurality of digital billboards is controlled by at least one billboard terminal.

### BACKGROUND

Digital billboards are computer-controlled electronic displays placed in prominent locations where there is automobile traffic, foot traffic, or other opportunities to be viewed by many people. Ad plays consisting of digital slides or video periodically rotate, for example, every six to ten seconds.

### BRIEF DESCRIPTION OF THE DRAWINGS

FIG. 1 shows a simplified block diagram of a digital billboard display system in accordance with an embodiment.

FIG. 2 illustrates a simplified user interface to a digital billboard display system in accordance with an embodiment.

FIG. 3 illustrates a simplified calendar interface to a digital billboard display system in accordance with an embodiment.

FIG. 4 is a simplified flowchart that describes process of a new campaign for a digital billboard display system in accordance with an embodiment.

FIG. 5 is a simplified flowchart that describes adjustment of campaign dates in accordance with an embodiment.

FIG. 6A, FIG. 6B and FIG. 6C provide an example of a performance report in accordance with an embodiment.

### DETAILED DESCRIPTION

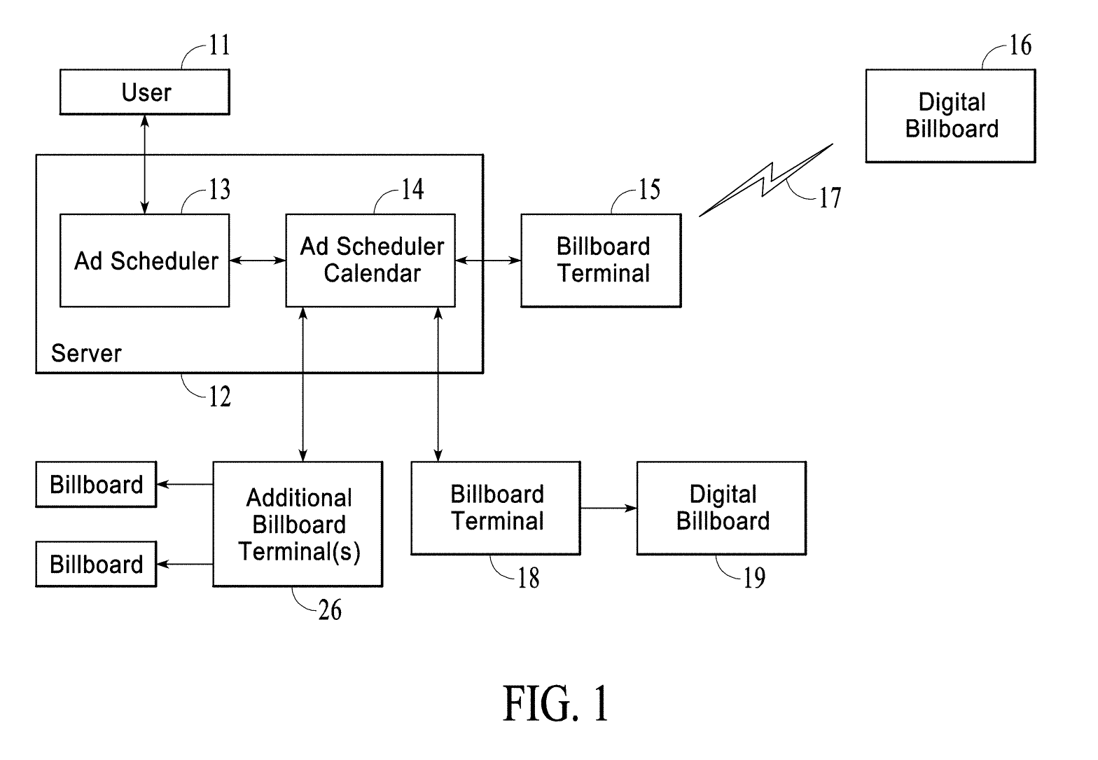

FIG. 1 shows a simplified block diagram of a digital billboard display system. An ad scheduler 13 and an ad scheduler calendar 14 reside on a server 12. While in FIG. 1 ad scheduler 13 and ad scheduler calendar 14 are shown to reside on a single server 12, functionality of ad scheduler 13 and ad scheduler calendar 14 can be spread to multiple servers, to a cloud of servers or to any other type of computing device or computing system. A user 11 interacts with ad scheduler 13 to schedule ad plays for an ad campaign. User 11 also interacts with ad scheduler 13 to pay for the ad campaign. Alternatively, depending on implementation, user 11 can interact with another payment entity to make payments that are tracked by ad scheduler 13 or some other payment tracking entity within the digital billboard display system.

Ad scheduler 13 uses an ad scheduler calendar 14 to schedule digital billboard displays for the ad campaign. The ad campaign can consist of digital billboard ad displays to be displayed upon a single digital billboard display or multiple digital billboard displays located within a defined or selected geographic region or other market region.

For example, the digital billboard ad displays consist of digital slides or video supplied or selected by the user. The digital billboard ads are played for a set period of time on each digital billboard and are rotated with other digital billboard ads from other users as scheduled within ad scheduler calendar 14. For example, each ad is played for six to ten seconds before the digital billboard plays another ad. Consecutively played ads are generally, but not necessarily, from different users.

When according to ad scheduler calendar 14, an ad campaign is schedule for display on digital billboards, ad scheduler calendar 14 will forward the ad content for the ad campaign to a billboard terminal 15. Alternatively, ad scheduler calendar 14 will notify billboard terminal 15 of the scheduled ad campaign while the ad impression(s) for the ad campaign will be supplied to billboard terminal 15 directly from user 11 or from another supplier of ad content.

For example, billboard terminal 15 is owned by an entity separate from the owner of ad scheduler 13. Alternatively, billboard terminal 15 is owned by the owner of ad scheduler 13. Billboard terminal 15 controls display of advertisements on one or more digital billboards. For example, in FIG. 1, billboard terminal 15 is shown in wireless communication with a digital billboard 16. The wireless connection is illustrated by wireless communication 17. Alternative to a wireless connection, billboard terminal 15 may be in communication with digital billboard 16 through a physical wire connection.

Digital billboard 16 is, for example, physically located where there is automobile or foot traffic or located at any other publicly visible location where there are opportunities to be viewed by many people. For example, digital billboard 16 could be placed at a sports stadium, shopping mall, shopping district, highway, busy city street, popular restaurant or anywhere many people would have a chance to see ads displayed by digital billboard 16. For example, ad impressions are the estimated viewings of ads during ad plays. Ads are, for example, digital slides or video displays. For example, each ad play is six to ten seconds.

For example, all the ads displayed by digital billboard 16 are scheduled by ad scheduler calendar 14. Alternatively, only a portion of the ads displayed by digital billboard 16 are scheduled by ad scheduler calendar 14, with other ads originating from the owner of billboard terminal 15, from other ad scheduler calendars or from other suppliers of ad content to digital billboards.

In addition to billboard terminal 15, ad scheduler calendar 14 can supply ad content to other billboard terminals. For example, FIG. 1 shows ad scheduler calendar 14 supplying ad content to a billboard terminal 18 in wireless or wired connection to a digital billboard 19. FIG. 1 also shows ad scheduler calendar 14 supplying ad content to a billboard terminal 20 in wireless or wired connection to multiple digital billboards.

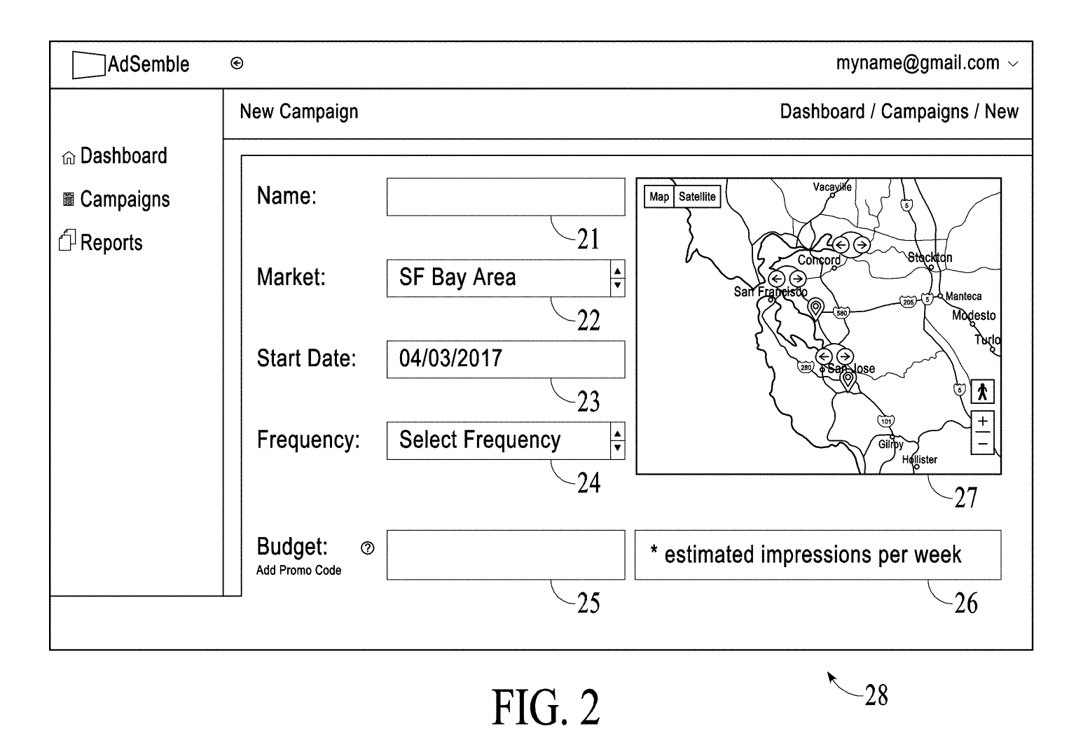

FIG. 2 shows a simplified user interface 28 for ad scheduler 13 that a user can use to initiate an ad campaign to be displayed on one or more digital billboards. In an input section 21, a user can enter the name of a person or company that is ordering the ad campaign. In an input section 22, the user can select a geographic region or market region in which the ad campaign will be displayed on digital billboards. For example, in FIG. 2, the user has selected the San Francisco (SF) bay area. As a result, in an area 27 a map of the SF bay area is shown with locations of billboards marked on the map.

In an input section 23, the user can select a start date for the campaign. In an area 24, the user can select a frequency for the ad campaign. For example, the frequency indicates time interval or duration of each ad campaign. The time interval for a campaign can be, for example, one week or multiple weeks. Alternatively, the time interval can be based on daily selection of ads to rotate on a billboard or even hourly or minute by minute rotation. This allows flexibility for a user, flexibility to determine length of an ad campaign on selected digital billboards.

In an input section 25, the user can specify the available budget for the campaign. On the basis of this, ad scheduler 13 calculates the number of ad impressions per week. In an area 26, ad scheduler 13 displays the calculated number of ad impressions per week. Each ad impression is an estimated viewing of the user's ad displayed on a digital billboard. For example, ad impressions for an ad are calculated by the amount of traffic (e.g. automobile or foot) past a digital billboard for a set period of time multiplied by the percent of the set period of time during which the ad is displayed.

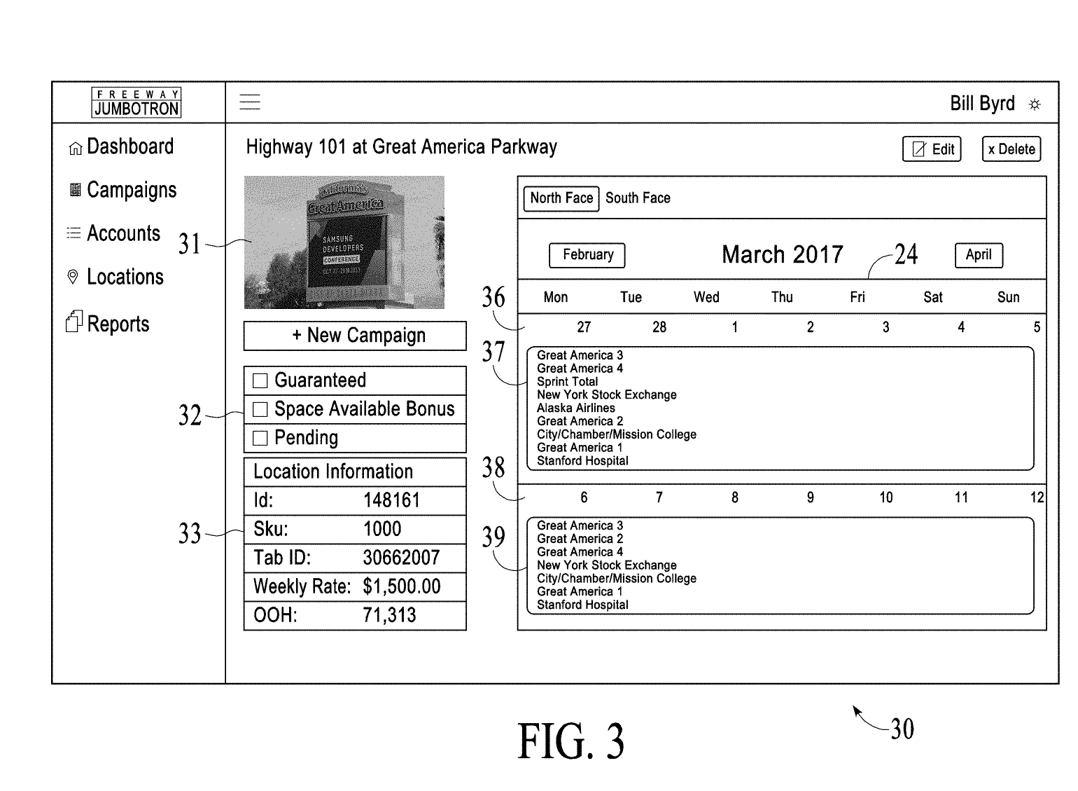

FIG. 3 illustrates a simplified calendar interface 30 for ad scheduler calendar 14. Simplified calendar interface 30 shows a schedule for a digital billboard located at Highway 101 near the Great America Parkway exit. A picture of the billboard is shown in an area 14. In an area 32, a color key for the color highlighting scheme for entities listed in area 37 and area 39 is given. One color highlight indicates the entity is guaranteed display of their ad on the digital billboard located at Highway 101 near the Great America Parkway exit. Another color highlight indicates the entity is may have their ad displayed on the digital billboard located at Highway 101 near the Great America Parkway exit if there as a space available bonus. A third color highlight indicates the entity has pending display of their ad on the digital billboard located at Highway 101 near the Great America Parkway exit. The pending status may be, for example, the result of the ad having not yet been paid for by the entity.

In a calendar area 24, a first calendar week is listed in a display area 36. The entities scheduled to have ads appear during the first week on the digital billboard located at Highway 101 near the Great America Parkway exit are listed in an area 37 displayed below area 36. The color highlighting scheme for each entity listed in area 37 indicate whether ads for the entity are guaranteed to be displayed, may be displayed based on a space available bonus, or are pending for display.

In calendar area 24, a second calendar week is listed in a display area 38. The entities scheduled to have ads appear during the second week on the digital billboard located at Highway 101 near the Great America Parkway exit are listed in an area 39 displayed below area 38. The color highlighting scheme for each entity listed in area 39 indicate whether ads for the entity are guaranteed to be displayed, may be displayed based on a space available bonus, or are pending for display.

y

For example, the user selects duration of an ad campaign using a selectable calendar date range picker. Alternatively, or in addition, the user is allowed to programmatically pick dates and times using a calendar to pick out particular dates and times to run, or to dates and times using algorithms that allow the user wide flexibility in picking dates and times.

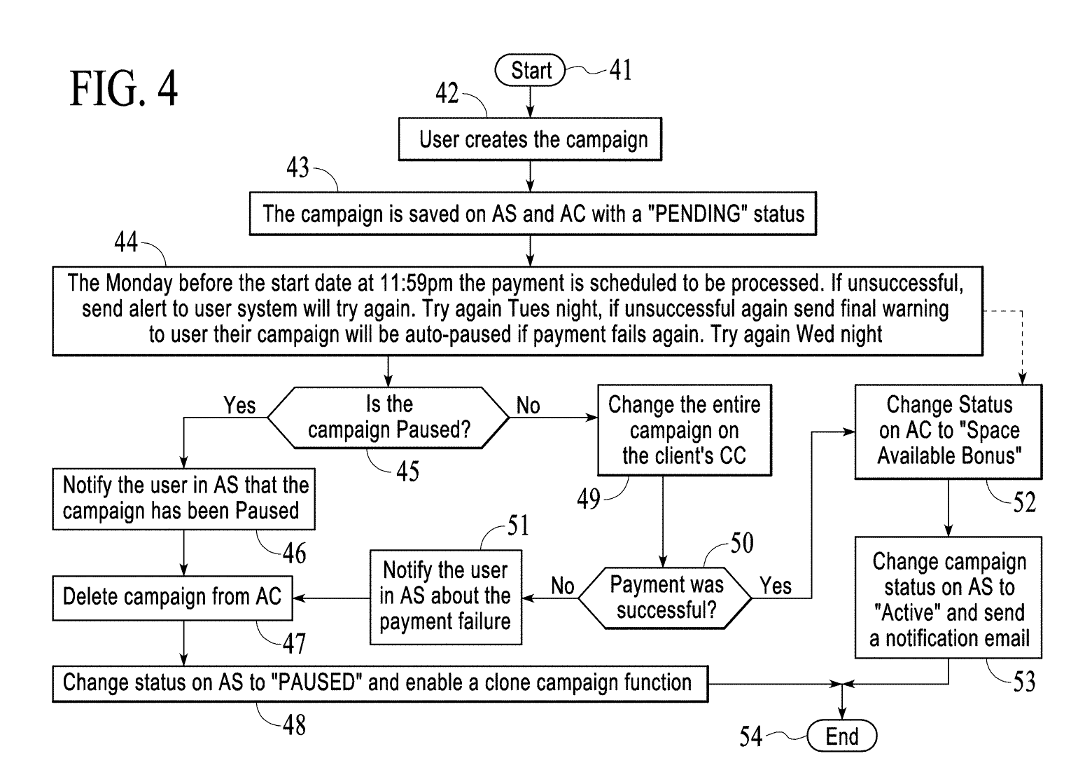

FIG. 4 is a simplified flowchart that describes process of a new campaign for a digital billboard display system. After a start block 41, in a block 42, a user creates a campaign, for example, using user interface 28 for ad scheduler 13. In a block 43, the campaign is saved within ad scheduler (AS) 13 and marked on ad scheduler calendar (AC) 14.

In a block 44, one week before the start date, the payment made by the user is processed. For example, when creating the campaign, the user provides credit card information to pay for the campaign. The credit card payment is processed on the Monday before the start date (e.g. at 11:49 PM). If the payment processing fails on Monday, an alert is sent to the user. Then, payment processing is tried again on Tuesday. If the payment processing fails on Tuesday, a final alert is sent to the user indicating the campaign will be auto paused if payment fails again. Then payment processing is tried again on Wednesday. If payment fails on Wednesday, the campaign will be paused. The one week before start date is exemplary. This period can be any time selected by the system.

After block 44, in block 45 a determination is made as to whether payment is to be paused or if payment processing is successful. If payment is to be paused, in a block 46, ad scheduler 13 notifies the user that the campaign is paused. In a block 47, the campaign is deleted from ad scheduler calendar 14. In a block 48, the status of the campaign within ad scheduler is changed to “PAUSED” and a clone campaign function is enabled. A clone campaign is a feature that allows a user to come back into their settings and replicate settings from a previous campaign. For example, after a user has updated a credit card, the user can “replicate” a previous campaign that was paused because of payment failure. In a block 54, the process ends.

If in block 45, the campaign is not to be paused, in a block 49, the entire campaign is charged on the client's credit card. If in a block 50, the payment is not successful, in a block 51, ad scheduler 13 notifies the user that the campaign is paused. In block 47, the campaign is deleted from ad scheduler calendar 14. In block 48, the status of the campaign within ad scheduler is changed to “PAUSED” and a clone campaign function is enabled. In block 54, the process ends.

If in block 50, the payment is successful, in a block 52, the status of the campaign within ad scheduler calendar 14 is listed as “Space Available Bonus”. In a block 53 the campaign status within ad scheduler 13 is changed to “Active” and a notification e-mail is sent to the user. In block 54, the process ends.

The status “Space Available Bonus” indicates how unreserved available space is divided up among users of a digital billboard.

For example, a digital billboard runs a new ad plays every 6 seconds. If each ad is played once a minute for an entire week, there is room for 10 ads to be played by the digital billboards, each of the 10 ads having an “ad slot” on the digital billboard. If, the digital billboard runs each day from 5 AM until 11 PM and then is shut off from 11 PM until 5 PM, each of the 10 different ads will be played 7,560 times per week. If all 10 ad slots are purchased, there is no space available bonus available on the digital billboard.

However, in only eight of the available ten ad slots for a week are sold, the remaining bundle of two ad slots are available to provide a space available bonus to the eight users that purchased one of the eight sold ad slots. Each of the eight users received an extra 1890 (2×7560÷8) ad plays as a space available bonus. If a single user purchased two of the eight sold ad slots for the week, that user receives received an extra 3,780 ad plays as a space available bonus. If a single user purchased all eight of the available ad slots for the week, that user receives 15,120 ad plays as a space available bonus.

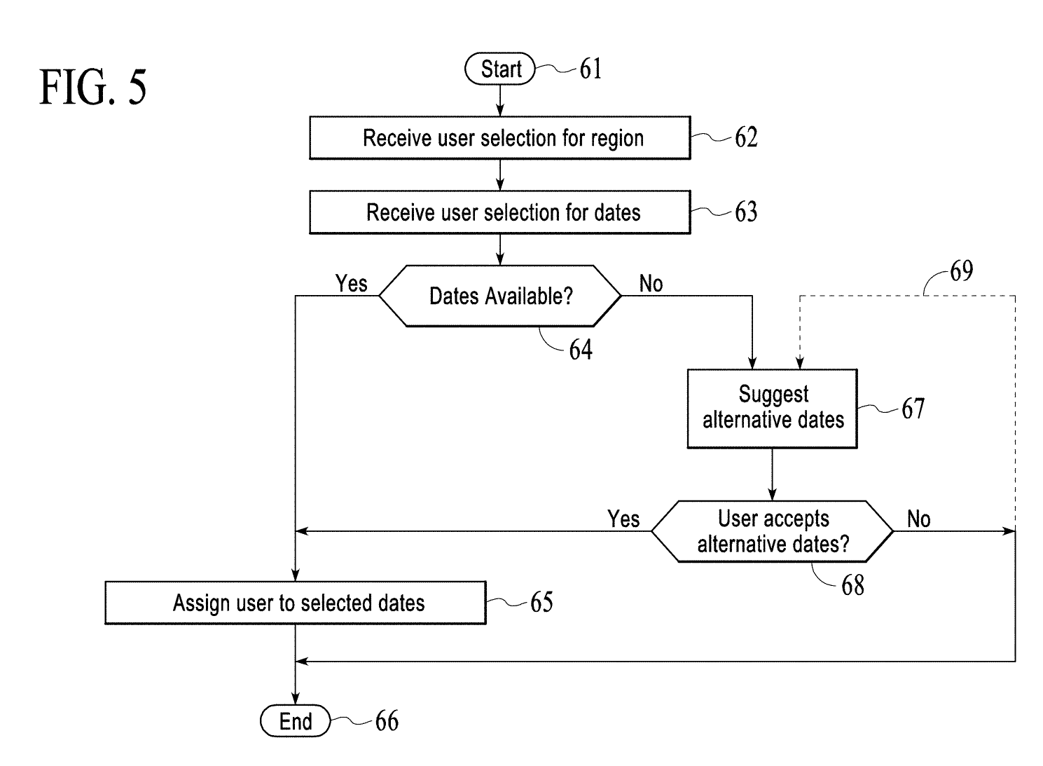

FIG. 5 is a simplified flowchart that shows adjustment of campaign dates. Specifically, after a start block 61, in a block 62, ad scheduler 13 receives a user selection for a region of an ad campaign. For example, the region may be the San Francisco Bay Area or any other region where ad scheduler 13 schedules digital displays.

In a block 63, ad scheduler 13 receives a user selection specifying desired dates for the ad campaign. In a block 64, ad scheduler 13 determines whether all those dates are available for the ad campaign. If all the dates are available for the ad campaign, in a block 65, ad scheduler 13 assigns the user ad campaign to the selected dates, and saves the campaign within ad scheduler 13 and marks the ad campaign on ad scheduler calendar 14. In a block 66, the process ends.

If in block 64, ad scheduler 13 determines ate least some of the requested dates are not available for the ad campaign, in a block 67, ad scheduler suggests alternative dates. For example, the user requests an ad campaign during four weeks in January, and ad scheduler 14 determines that space for the ad campaign is only available the last two weeks of January. In this case, for example, ad scheduler 14 will suggest the ad campaign include the last two weeks of January and the first two weeks of February if advertising space in the San Francisco Bay Area is available all those weeks. This suggestion keeps in place the original length of the campaign (four weeks) as well as keeps in place the ad campaign running completely in contiguous weeks.

If in a block 68 the suggested dates for the ad campaign are acceptable for the user, in block 65, ad scheduler 13 assigns the user ad campaign to the selected dates, saves the campaign within ad scheduler 13 and marks the ad campaign on ad scheduler calendar 14. In block 66, the process ends.

If block 68 the suggested dates for the ad campaign are not acceptable for the user, additional alternative dates can be suggested, as illustrated by a dashed line 69. Otherwise, if no acceptable alternative dates are acceptable to the user, in block 66, the process ends.

For example, after starting an ad campaign, statistical information about location, frequency, number of ad impressions is returned to a user so that the user can run detailed analytics reports on number of plays and ad impressions, location, frequency, number of ad impressions that occur during the ad campaign. For example, the analytic reports can include automatically calculating variances at each individual screen level as well as an overall “Total” variance+/−for the ad campaign as a whole.

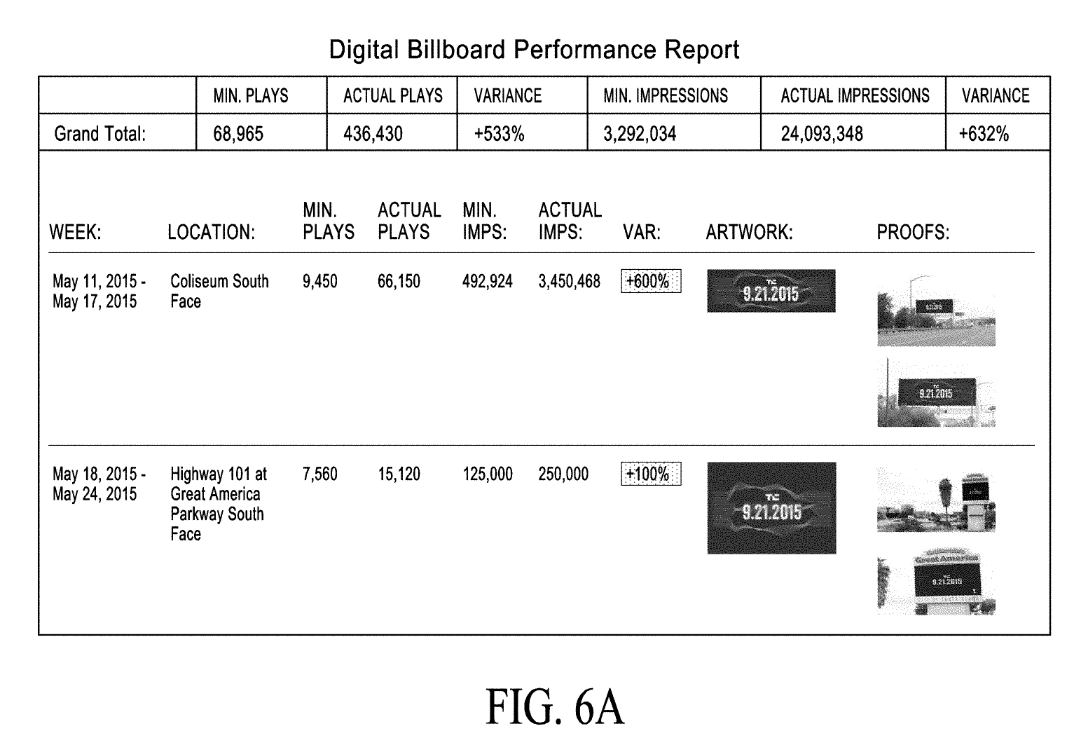

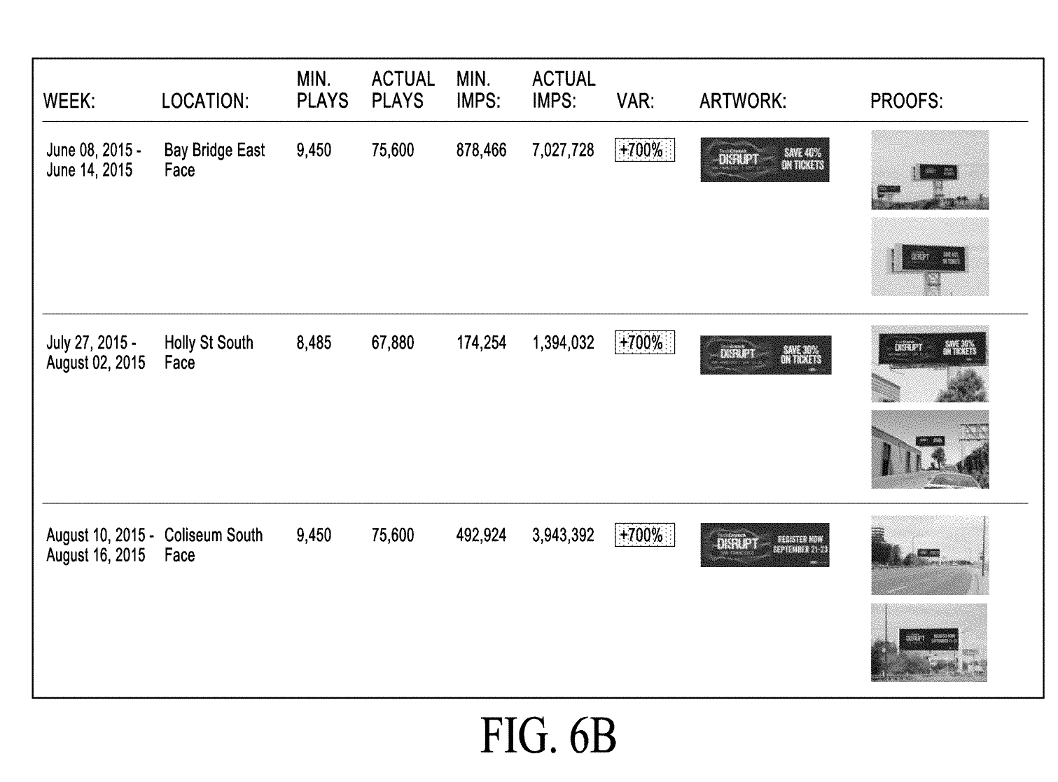

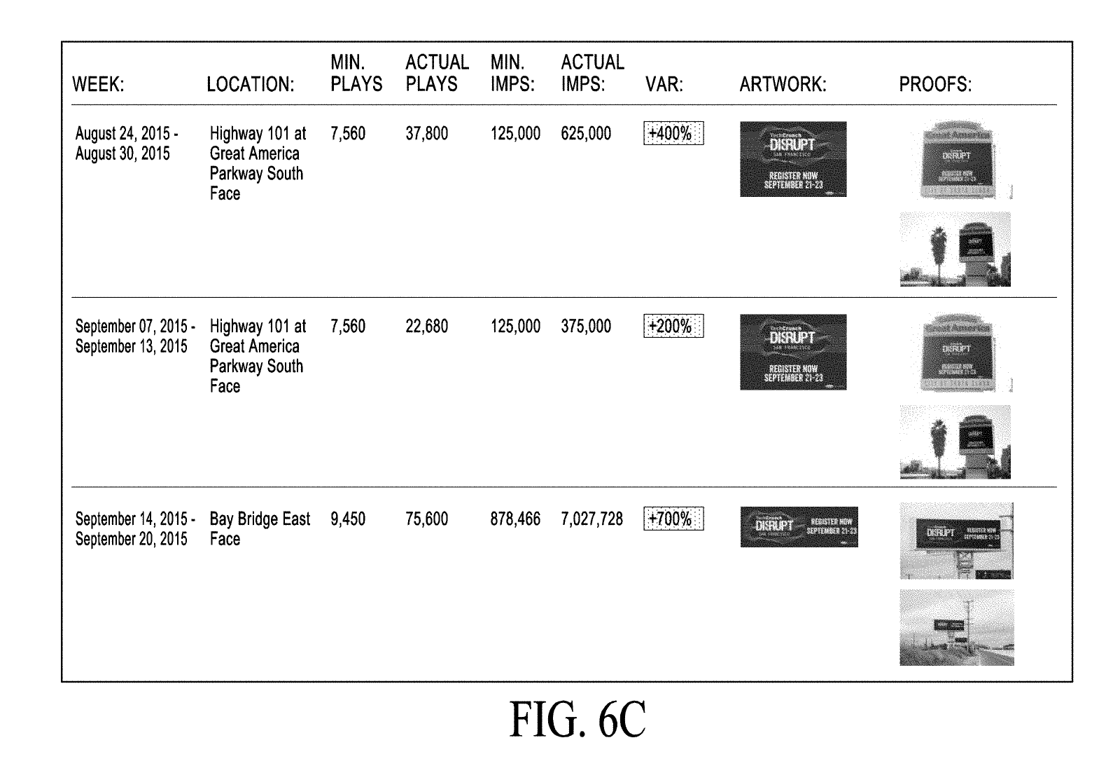

FIG. 6A, FIG. 6B and FIG. 6C provide an example of three pages of a performance report that provide performance information to a user for an ad campaign with ads that extends over eight different weeks with ads appearing of digital billboards within a defined geographic region on eight different digital billboards. For each week, the performance report lists the week, the location of the digital billboard on which ads were displayed, the minimum number of ad plays, the actual number of ad plays, the minimum estimated number of ad impressions, the actual estimated number of ad impressions, the variance (based on actual impressions divided my minimum impressions), a miniature of the ad artwork and a snapshot showing the ad being displayed on the digital billboard. In addition, grand totals for the ad campaign are disclosed at the top of FIG. 6A that lists for the entire ad campaign the minimum number of ad plays, the actual number of ad plays, the minimum estimated number of ad impressions, the actual estimated number of ad impressions and the variance (based on actual estimated impressions divided my minimum estimated impressions). The actual performance report can vary based on implementation. For example, in one implementation, the digital billboard performance report displays for each digital billboard a minimum number of ad plays, an actual number of ad plays, a minimum estimated number of ad impressions and an actual estimated number of ad impressions, the digital billboard performance report including totals for an ad campaign including a minimum number of ad plays, an actual number of ad plays, a minimum estimated number of ad impressions, an actual estimated number of ad impressions, images of an ad creative message and photos of the ad creative message displayed on the digital billboard.

For example, a database for the digital billboard schedule is accessible through means of an application programming interface (API) to third party applications such as available from applications such as Google and Facebook applications. The information accessible in the database includes, for example, billboard location, impressions, plays, latitude/longitude, calendar information and advertiser campaign information such as campaign name, date range, budget, creatives.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention.

What is claimed is:

1. An advertising system, comprising:
a plurality of geographically dispersed digital billboards placed in publicly visible locations;
at least one billboard terminal, in communication with the plurality of geographically dispersed digital billboards, the at least one billboard terminal controlling ads displayed by the plurality of geographically dispersed digital billboards;
an ad scheduling calendar; and,
an ad scheduler that schedules ad campaigns consisting of ads to be displayed on the plurality of geographically dispersed digital billboards, for each ad campaign the ad scheduler receiving from a user input as to a region for the ad campaign, a start date for the ad campaign and an estimated number of ad impressions within a set period of time for the ad campaign, the ad scheduler, scheduling the ad campaign in the ad scheduling calendar;
wherein when the ad campaign scheduled in the ad scheduling calendar is approved, the at least one billboard terminal displays ads on digital billboards within the plurality of geographically dispersed digital billboards that are within the region for the ad campaign.

2. An advertising system as in claim 1, wherein the at least one billboard terminal includes one billboard terminal for every digital billboard within the plurality of geographically dispersed digital billboards.

3. An advertising system as in claim 1, wherein the ad scheduler includes a clone feature that allows the user to replicate settings from a previous campaign.

4. An advertising system as in claim 1, wherein the estimated number of ad impressions within the set period of time is based on a budget set by the user for the ad campaign.

5. An advertising system as in claim 1, wherein the ad campaign scheduled in the ad scheduling calendar is approved when the user makes required payments for the ad campaign and is paused when the user fails to make required payments for the ad campaign.

8. An advertising system as in claim 1, wherein the user is provided a digital billboard performance report that displays for each digital billboard a minimum number of ad plays, an actual number of ad plays, a minimum estimated number of ad impressions and an actual estimated number of ad impressions, the digital billboard performance report including totals for an ad campaign including a minimum number of ad plays, an actual number of ad plays, a minimum estimated number of ad impressions, an actual estimated number of ad impressions, images of an ad creative message and photos of the ad creative message displayed on the digital billboard.

7. An advertising system as in claim 1, wherein the user is provided a digital billboard performance report that displays for each digital billboard a minimum number of ad plays, an actual number of ad plays, a minimum estimated number of ad impressions and an actual estimated number of ad impressions.

8. An advertising system as in claim 1, wherein the user is provided a digital billboard performance report that displays for each digital billboard a minimum number of ad plays, an actual number of ad plays, a minimum estimated number of ad impressions and an actual estimated number of ad impressions, the digital billboard performance report including totals for an ad campaign including a minimum number of ad plays, an actual number of ad plays, a minimum estimated number of ad impressions and an actual estimated number of ad impressions.

9. An advertising system as in claim 1:
wherein for each ad campaign the ad scheduler receives from the user input as to duration from the start date, the time is to run; and,
wherein when any times for the ad campaign requested by the user are not available, the ad scheduler suggests alternative times for the ad campaign.

10. An advertising system as in claim 9:
wherein when the user originally requests contiguous weeks for the ad campaign, if the contiguous weeks are not available for the ad campaign, the ad scheduler suggests contiguous alternative weeks for the ad campaign.

11. An advertising system as in claim 1 additionally comprising:
a database accessible through means of an application programming interface, wherein the information accessible in the database includes, digital billboard location, impressions, plays, latitude/longitude, calendar information and advertiser campaign information.

12. An advertising system, comprising:
a digital billboard placed in a publicly visible location;
a billboard terminal, in communication with the digital billboard, the at least one billboard terminal controlling ads displayed by the plurality of geographically dispersed digital billboards;
an ad scheduling calendar; and,
an ad scheduler that schedules ad campaigns consisting of ads to be displayed on the digital billboard, for each ad campaign the ad scheduler receiving from a user input as to a start date for the ad campaign and an estimated number of impressions within a set period of time for the ad campaign, the ad scheduler, scheduling the ad campaign in the ad scheduling calendar;
wherein when the ad campaign scheduled in the ad scheduling calendar is approved, the billboard terminal displays ads on the digital billboard for the ad campaign;
wherein for each ad campaign the ad scheduler receives from the user input as to duration from the start date, the time is to run; and,
wherein when any times for the ad campaign requested by the user are not available, the ad scheduler suggests alternative times for the ad campaign.

13. An advertising system as in claim 12, wherein the estimated number of impressions within the set period of time is based on a budget set by the user for the ad campaign.

14. An advertising system as in claim 12, wherein the ad campaign scheduled in the ad scheduling calendar is paused when the user fails to make required payments for the ad campaign.

15. An advertising system as in claim 12, wherein the ad campaign scheduled in the ad scheduling calendar is paused when the user fails to make required payments for the ad campaign.

16. An advertising system as in claim 12:
wherein when the user originally requests contiguous weeks for the ad campaign, if the contiguous weeks are not available for the ad campaign, the ad scheduler suggests contiguous alternative weeks for the ad campaign.

17. A computer implemented method for performing an advertising campaign comprising:
receiving, by a computer implemented an ad scheduler, input from a user, the input including a region for an ad campaign, a start date for the ad campaign and an estimated number of impressions within a set period of time for the ad campaign,
scheduling, by the computer implemented ad scheduler, the ad campaign in a computer implemented ad scheduling calendar; and,
displaying, by a plurality of digital billboards located within the region for the ad campaign, ads for the ad campaign including the following:
controlling the plurality of digital billboards by at least one billboard terminal.

18. A computer implemented method as in claim 17 wherein the ad campaign scheduled in the ad scheduling calendar is paused when the user fails to make required payments for the ad campaign.

19. A computer implemented method as in claim 17:
wherein for each ad campaign the ad scheduler receives from the user input as to duration from the start date, the time is to run; and,
wherein when any times for the ad campaign requested by the user are not available, the ad scheduler suggests alternative times for the ad campaign.

20. A computer implemented method as in claim 19:
wherein when the user originally requests contiguous weeks for the ad campaign, if the contiguous weeks are not available for the ad campaign, the ad scheduler suggests contiguous alternative weeks for the ad campaign.
